(19) United States
(12) Patent Application Publication
(10) Pub. No.: US 2007/0129485 A1
(43) Pub. Date: Jun. 7, 2007

(54) Water-base metallic coating for automotive interior materials and coated article

(75) Inventors: Tomoko Iida, Wako-shi (JP); Tatsuya Itakura, Wako-shi (JP); Takashi Watanabe, Hirakata-shi (JP); Isao Furutsuka, Hirakata-shi (JP)

Correspondence Address: ROBERT J JACOBSON PA, 650 BRIMHALL STREET SOUTH, ST PAUL, MN, 551161511, US

(73) Assignees: Honda Motor Co., Ltd.; Nippon Bee Chemical Co., Ltd.

(21) Appl. No.: 11/604,070

(22) Filed: Nov. 24, 2006

(30) Foreign Application Priority Data
Dec. 7, 2005 (JP) 2005-353221
Mar. 2, 2006 (JP) 2006-056659

(51) Int. Cl. C08K 5/00

(52) U.S. Cl. 524/515

(57) ABSTRACT

An object of the present invention is to provide a water-base metallic coating for automotive interior materials being single-coat metallic finished which is excellent in adhesion to a substrate and fats and oils resistance and is further provided with so high alkali resistance as to be free from being whitened or discolored even by an aqueous high-concentration alkali solution. As a means of achieving this object, the water-base metallic coating for automotive interior materials according to the present invention comprises a metallic pigment and a vehicle, and is characterized in that the vehicle includes: a first water-based hydro-dispersion resin (A) obtained by hydro-dispersing, without using a surfactant, an acrylic resin which indispensably contains isobomyl methacrylate as a monomer component and no styrene and has a theoretical Tg in a range from 80 to 140° C., an acid value in a range from 10 to 25 mgKOH/g, and an SP value in a range from 9.5 to 10.0; and a second water-based hydro-dispersion resin (B) obtained by hydro-dispersing, without using a surfactant, an acid-modified chlorinated polyolefin resin having an acid modification quantity in a range from 1.6 to 2.5% by mass, a chlorine content in a range from 18 to 25%, and a weight average molecular weight in a range from 50,000 to 80,000.

### BACKGROUND OF THE INVENTION

A. TECHNICAL FIELD

The present invention relates to: a water-base coating for automotive interior materials which has a metallic color; and a coated article (e.g. automotive interior materials) coated with this water-base metallic coating.

B. BACKGROUND ART

Various kinds of plastic materials have been used for automotive interior materials while being selected in accordance with the physical properties required for product specification, and coating of the plastic materials has been done properly for the interior materials. In recent years, metallic colors with high patterning and designing properties have been becoming sharply popular as a coating color for the automotive interior materials, and the demand for coatings exhibiting metallic colors for automotive interior materials has been increasing.

A metallic color is generated by adding a brilliant pigment such as aluminum, copper, zinc, or the like into a coating. An acrylic resin is the most suitable for a vehicle composing such a coating. It is because the resin is excellent in stain resistance against such as grease and engine oil, printing resistance and scratching resistance. However, acrylic resin has such weakness that it is difficult to increase the addition amount as the resin has no high adhesion property to a plastic material. To deal with this weakness, a chlorinated polyolefin resin is used in combination with the acrylic resin (refer to Patent Document 1 below, etc.).

In recent years, under the increasing demand for reduction of organic solvent discharge in terms of environmental protection, various kinds of coatings are also required to replace conventional organic solvent type coatings with water-base coatings. Accordingly, as to the metallic coating described in Patent Document 1 below, the acrylic resin being provided with a hydrophilic functional group is formed into an emulsion by using a surfactant, and the chlorinated polyolefin resin is also formed into an emulsion by using a surfactant, thus devising to design the coating to be water-based.

However, a coating film of a resin having a large quantity of a hydrophilic functional group is adversely poor at water resistance and alkali resistance. Furthermore, a coating film of an emulsion resin which contains a large quantity of a surfactant being a hydrophilic substance for the purpose of keeping the stability in water is also inferior in alkali resistance. That is, there is a demerit that the coating film tends defectively to be immersed with an aqueous alkali solution in the state where the coating film is exposed to the aqueous alkali solution.

Therefore, with respect to conventional water-base coatings, for example, in the case that a metallic color is exhibited by adding a metallic pigment such as aluminum flakes, there might be a problem occurred that if a formed coating film is exposed to an aqueous alkali solution, the metallic pigment in the coating film is dissolved by the aqueous alkali solution, thus resulting in whitening or discoloration of the coating film. An automotive interior material is sometimes wiped with an alkaline detergent such as a soap liquid, a window washer liquid, or the like after being assembled as a product in an automobile and sold, and therefore a coating for automotive interior materials is particularly required to be free from the above-mentioned problems of whitening or discoloration due to the dissolution of the metallic pigment into the aqueous alkali solution. To make the water-base coating for automotive interior materials exhibiting a metallic color, it is accordingly required for the coating film to be free from whitening or discoloration by the aqueous alkali solution.

In view of the above-mentioned problems, with regard to designing the acrylic resin to be water-based, the inventors of the present invention first developed a technology of designing the acrylic resin to be water-based without using a surfactant, by being hydrosol formed by adjusting the acid value of the acrylic resin (refer to Patent Documents 2 and 3 below). On the other hand, techniques of designing a chlorinated polyolefin resin to be water-based without using a surfactant, by acid-modified chlorinated polyolefin resin and successively neutralizing the resin with a basic substance, have also been developed recently (refer to Patent Document 4 below).

[Patent Document 1] JP-A-2001-002977 (Kokai)

[Patent Document 2] JP-A-2005-132927 (Kokai)

[Patent Document 3] JP-A-2005-132928 (Kokai)

[Patent Document 4] JP-A-2004-018659 (Kokai)

However, with respect to the above-mentioned conventional water-base coatings for automotive interior materials, none of devices of designing the coatings to be water-based has resulted in sufficient alkali resistance. Therefore, no water-base metallic coating for automotive interior materials has been put into practical use so far.

On the other hand, also with respect to the acrylic resin, attempts have been made to prevent occurrence of whitening or discoloration even under long time contact with an aqueous alkali solution, by using styrene as a monomer and thereby heightening film formability. However, the use of styrene may possibly lower the fats and oils resistance of a coating film.

### SUMMARY OF THE INVENTION

### A. OBJECT OF THE INVENTION

Accordingly, an object of the present invention is to avoid the use of a surfactant and thereby provide a water-base metallic coating for automotive interior materials being single-coat metallic finished which is excellent in adhesion to a substrate and fats and oils resistance and which, although styrene-free, is further provided with so high alkali resistance as to prevent occurrence of whitening or discoloration even under long time contact with an aqueous alkali solution.

### B. DISCLOSURE OF THE INVENTION

The inventors of the present invention have devoted themselves to solve the above-mentioned problems. As a result, the inventors have found it possible to obtain a water-base coating that enables the film to be excellent in adhesion to a substrate and fats and oils resistance and also alkali resistance by using a vehicle comprising a combination of: a material obtained in the way that a styrene-free acrylic resin having a theoretical Tg, an acid value, and an SP value in their respective specified ranges is formed into a hydro-sol without using a surfactant; and a material obtained in the way that an acid-modified chlorinated polyolefin resin having an acid modification quantity, a chlorine content and a weight average molecular weight in their respectively specified ranges is formed into a hydro-sol without using a surfactant. Then, the inventors have completed the present invention by confirming that such a coating solves the above-mentioned problems all at once.

That is, a water-base metallic coating for automotive interior materials of the present invention comprises a metallic pigment and a vehicle, and is characterized in that the vehicle includes: a first water-based hydro-dispersion resin A obtained by hydro-dispersing, without using a surfactant, an acrylic resin which indispensably contains isobomyl methacrylate as a monomer component and no styrene and has a theoretical Tg in a range from 80 to 140° C., an acid value in a range from 10 to 25 mgKOH/g, and an SP value in a range from 9.5 to 10.0; and a second water-based hydro-dispersion resin B obtained by hydro-dispersing, without using a surfactant, an acid-modified chlorinated polyolefin resin having an acid modification quantity in a range from 1.6 to 2.5% by mass, a chlorine content in a range from 18 to 25%, and a weight average molecular weight in a range from 50,000 to 80,000.

As to the above-mentioned water-base metallic coating for automotive interior materials of the present invention, it is preferable that the ratio of the isobomyl methacrylate in polymerizable monomer components for synthesizing the acrylic resin is in a range from 20 to 50% by mass. It is also preferable that the mutual ratio (solid matter ratio A/B) of the hydro-dispersion resin A and the hydro-dispersion resin B is in a range from 6/4 to 8/2. It is also preferable that the ratio of the total solid matter of the hydro-dispersion resin A and the hydro-dispersion resin B to the total solid matter of the coating is in a range from 70 to 98% by mass. It is also preferable that the ratio of the metallic pigment to the total solid matter of the coating is in a range from 1 to 15% by mass.

In addition, a coated article of the present invention is an article coated with the above-mentioned water-base metallic coating, including preferable modes for carrying out the present invention.

### C. EFFECTS OF THE INVENTION

According to the water-base metallic coating for automotive interior materials of the present invention, while satisfying the requirements for environmental protection at the time of coating, a coating film formed by single coat finishing from the above-mentioned water-base metallic coating is excellent in adhesion to a substrate and fats and oils resistance and, although styrene-free, is further provided with so high alkali resistance as even to avoid whitening or discoloration caused by long time contact with an aqueous alkali solution and can exhibit a metallic color giving high patterning and designing property for automotive interior materials.

### DETAILED DESCRIPTION OF THE INVENTION

The water-base metallic coating for automotive interior materials of the present invention is a coating comprising a vehicle and a metallic pigment, wherein the vehicle includes the above specified water-based hydro-dispersion resin A and the above specified water-based hydro-dispersion resin B.

Hereinafter, detailed descriptions are given about these constituent elements However, the scope of the present invention is not bound to these descriptions. And other than the following illustrations can also be carried out in the form of appropriate modifications of the following illustrations within the scope not departing from the spirit of the present invention.

<With Respect to the First Water-Based Hydro-Dispersion Resin A>

The first water-based hydro-dispersion resin A to be used in the present invention is obtained by hydro-dispersing, without using a surfactant, an acrylic resin which indispensably contains isobomyl methacrylate as a monomer component and no styrene and has a theoretical Tg in a range from 80 to 140° C., an acid value in a range from 10 to 25 mgKOH/g, and an SP value in a range from 9.5 to 10.0.

It will do that the polymerizable monomer components composing the acrylic resin indispensably include isobomyl methacrylate and further include a proper amount of an α,β-ethylenically unsaturated monomer such as (meth)acrylic acid and/or (meth)acrylates. Incidentally, the reason why the polymerizable monomer components composing the acrylic resin include isobomyl methacrylate as an indispensable component is because the alkali resistance is made high. The ratio of isobomyl methacrylate in the polymerizable monomer components is not particularly limited. However, it is preferably in a range from 20 to 50% by mass in the polymerizable monomer components. If the ratio of isobornyl methacrylate is lower than 20% by mass, the alkali resistance may be possibly inferior. On the other hand, if the ratio of isobomyl methacrylate exceeds 50% by mass, the film formability may be possibly inferior.

Examples of the above-mentioned a,p-ethylenically unsaturated monomer having an acid group include (meth)acrylic acid, acrylic acid dimer, crotonic acid, 2-acryloyloxyethylphthalic acid, 2-acryloyloxyethylsuccinic acid, 2-acryloyloxyethyl acid phosphate, 2-acrylamido-2-methylpropanesulfonic acid, ω-carboxy-polycaprolactone mono(meth)acrylate, isocrotonic acid, α-hydro-ω-[(1-oxo-2-propenyl)oxy]poly[oxy(1-oxo-1,6-hexanediyl)], maleic acid, fumaric acid, itaconic acid, 3-vinylsalicylic acid, and 3-vinylacetylsalicylic acid. Among them, acrylic acid and methacrylic acid are particularly preferable. The above-mentioned α,β-ethylenically unsaturated monomers may be used alone or in combination of two or more thereof.

The ratio of the α,β-ethylenically unsaturated monomer having an acid group in the polymerizable monomer components may be set properly for the acid value of the acrylic resin to be in a range from 10 to 25 mgKOH/g.

As a monomer other than the α,β-ethylenically unsaturated monomer having an acid group, the polymerizable monomer components may further include a monomer having a hydroxyl group. Examples of the monomer having a hydroxyl group include hydroxyethyl (meth)acrylate, hydroxypropyl (meth)acrylate, hydroxybutyl (meth)acrylate, allyl alcohol, methallyl alcohol, and adducts of hydroxyethyl (meth)acrylate and ε-caprolactone. The monomers having a hydroxyl group may be used alone or in combination of two or more thereof.

In the case the above-mentioned polymerizable monomer components include the monomer having a hydroxyl group, the ratio of the monomer having a hydroxyl group in the polymerizable monomer components is not particularly limited. However, it is preferable to set the ratio for the hydroxyl value of the acrylic resin to be 20 mgKOH/g or lower.

If necessary, the above-mentioned monomer components may further contain an α,β-ethylenically unsaturated monomer other than the α,β-ethylenically unsaturated monomer having an acid group. Examples of the other α,β-ethylenically unsaturated monomer include: (meth)acrylic acid esters such as methyl (meth)acrylate, ethyl (meth)acrylate, n-butyl (meth)acrylate, isobutyl (meth)acrylate, t-butyl (meth)acrylate, 2-ethylhexyl (meth)acrylate, lauryl methacrylate, phenyl acrylate, cyclohexyl methacrylate, t-butylcyclohexyl (meth)acrylate, dicyclopentadienyl (meth)acrylate, and dihydrodicyclopentadienyl (meth)acrylate; polymerizable amide compounds such as (meth)acrylamide, N-methylol(meth)acrylamide, N,N-dimethyl(meth)acrylamide, N,N-dibutyl(meth)acrylamide, N,N-dioctyl(meth)acrylamide, N-monobutyl(meth)acrylamide, N-monooctyl(meth)acrylamide, 2,4-dihydroxy-4′-vinylbenzophenone, and N-(2-hydroxyethyl)(meth)acrylamide; polymerizable aromatic compounds such as vinyl ketone and vinylnaphthalene; polymerizable nitriles such as (meth)acrylonitrile; α-olefins such as ethylene and propylene; vinyl esters such as vinyl acetate and vinyl propionate; and dienes such as butadiene and isoprene. As mentioned above, other α,β-ethylenically unsaturated monomers may be used alone or in combination of two or more thereof.

A polymerization initiator which can be used in solution polymerization for obtaining the acrylic resin is not particularly limited. However, examples are as follows: azo type polymerization initiators such as azobisisobutyronitrile; and peroxide type polymerization initiators such as benzoyl peroxide, p-chlorobenzoyl peroxide, lauroyl peroxide, and t-butyl perbenzoate. Polymerization initiators may be used alone or two or more of them may be used in combination. Incidentally, in the aforementioned polymerization, if necessary, in order to adjust the molecular weight, a chain transfer agent such as mercaptan (e.g. laurylmercaptan) may be used.

Solution polymerization for obtaining the acrylic resin may use solvents such as: aromatic hydrocarbons such as toluene and xylene; aliphatic hydrocarbons such as hexane, heptane, and octane; esters such as ethyl acetate, n-butyl acetate, isobutyl acetate, and amyl acetate; ethers such as propylene glycol monomethyl ether; ketones; alcohols or their derivatives; diethylene glycol or its derivatives; propylene glycol or its derivatives; and dioxane, N-methylpyrrolidone, and dimethylformamide. These solvents may be used alone or in combination of two or more thereof.

A method for the solution polymerization is not particularly limited. However, for example, the method may be carried out by a process including the sequential steps of: charging a solvent into a reaction container, heating the solvent to a prescribed reaction temperature, dropwise adding the polymerizable monomer components and the polymerization initiator to the reaction container at the temperature, and carrying out the polymerization at a constant temperature for a prescribed duration. In this process, the reaction temperature is adjusted preferably in a range from 60 to 100° C. and the reaction time is adjusted preferably in a range of approximately 5 to 8 hours.

It is important for the acid value of the acrylic resin to be in a range from 10 to 25 mgKOH/g. The use of the water-based hydrosol resin (A) obtained by forming a water-base acrylic resin having such a specified acid value into a hydro-sol, as one of the vehicles, makes it possible to avoid whitening or discoloration, caused by a high concentration alkali, of a coating film formed from the water-base metallic coating of the present invention. If the acid value of the acrylic resin is lower than 10 mgKOH/g, the acrylic resin cannot become water-based and no water-base coating can be obtained. On the other hand, if it exceeds 25 mgKOH/g, the alkali resistance of the water-based hydrosol resin (A) to be obtained becomes insufficient, so that when a metallic pigment is added, the formed coating film is whitened or discolored by an aqueous alkali solution.

It is important for the acrylic resin being used in the present invention to have a theoretical Tg in a range from 80 to 140° C. and an SP value in a range from 9.5 to 10.0. If the theoretical Tg of the acrylic resin is lower than 80° C., the alkali resistance is lowered and the stain resistance such as fats and oils resistance and printing resistance tend to be deteriorated. On the other hand, if the theoretical Tg of the acrylic resin is higher than 140° C., the film formability becomes inferior. If the SP value of the acrylic resin is lower than 9.5, the stain resistance such as fats and oils resistance tends to be deteriorated and, if the SP value of the acrylic resin exceeds 10.0, the alkali resistance is lowered.

In the present invention, the Tg of the acrylic resin is theoretically computed according to the following equation:
1/Tg=Σ(Wn/Tgn)
wherein: Wn denotes the content of each monomer for obtaining the acrylic resin; and Tgn denotes the measured Tg of a homopolymer obtained from each monomer alone.

The measurement of Tg of the homopolymer is carried out by a method in which: volatile components of the homopolymer obtained by homopolymerization are distilled off under vacuum; and then, using a differential scanning calorimeter (DSC; a thermal analyzer SSC/5200 H manufactured by Seiko Instruments Inc.), the residual homopolymer is treated by a first step of heating from 20° C. to 100° C. (at heating rate of 10° C./min), a second step of cooling from 100° C. to −50° C. (at cooling rate of 10° C./min), and a third step of heating from −50° C. to 100° C. (at heating rate of 10° C./min), wherein Tg is measured when raising the temperature in the third step. The measured value of Tg of the homopolymer is, for example, 180° C. for an isobomyl methacrylate homopolymer, −54° C. for an n-butyl acrylate homopolymer, 185° C. for a methacrylic acid homopolymer, 48° C. for an isobutyl methacrylate homopolymer, 105° C. for a methyl methacrylate homopolymer, and 107° C. for a tert-butyl methacrylate homopolymer.

On the other hand, the SP value of the acrylic resin is a value calculated by the following method (refer to Suh, Clarke [J. P. S. A-1, 5, 1671-1681 (1967)]): 0.5 g of the acrylic resin is weighed out and put into a 100 ml beaker and dissolved by adding 10 ml of a good solvent (dioxane and/or acetone) to obtain a solution as a sample, and then a poor soluble solvent (n-hexane and/or deionized water) is dropwise added to the solution of a temperature of 20° C. by a buret, and the dropwise addition amount is measured down to the first decimal point when the solution becomes turbid.

To adjust the Tg and SP value of the acrylic resin into their respective aforementioned specified numerical value ranges, for example, when the necessary amount of the isobomyl methacrylate (which is an indispensable monomer) and the necessary amount of the α,β-ethylenically unsaturated monomer having an acid group for obtaining the needed acid value are set and further the copolymerization composition of the monomer other than the α,β-ethylenically unsaturated monomer having an acid group is also set, then these settings are made so that the above-mentioned theoretical Tg and measured SP value will come within their respective aforementioned specified numerical value ranges.

The weight average molecular weight of the acrylic resin is not particularly limited. However, for example, it is preferably in a range from 15,000 to 100,000.

The method for hydro-dispersing the acrylic resin is not particularly limited and publicly known conventional methods may be applied. Examples of the methods include: 1) a method in which a resin solution of an acrylic resin obtained by the aforementioned polymerization is added to a container containing a neutralization agent and water and forcedly dispersed into water; 2) a method in which the aforementioned resin solution is neutralized by adding a neutralization agent, and then the neutralized resin solution is dispersed into water while being added to a container containing water under stirring; and 3) a method in which the aforementioned resin solution is neutralized by adding a neutralization agent, and then water of a high temperature is added to the neutralized resin solution while slightly heating the neutralized resin solution under stirring, whereby the phase of the resin solution is reversed to disperse into water.

The aforementioned neutralization agent to be used for hydro-dispersing of the acrylic resin is not particularly limited. The following can be used: organic amine compounds such as primary amines, secondary amines and tertiary amines; and ammonia water. Specific examples of the organic amines include: alkylamines such as monoethylamine, diethylamine, triethylamine, and tributylamine; and alkanolamines such as monoethanolamine, diethanolamine, dimethylethanolamine, and methylpropanolamine. The neutralization agents may be used alone or in combination of two or more thereof.

<With Respect to the Second Water-Based Hydro-Fispersion Resin B>

The water-based hydro-dispersion resin B is obtained by hydro-dispersing, without using a surfactant, an acid-modified chlorinated polyolefin resin having an acid modification quantity in a range from 1.6 to 2.5% by mass, a chlorine content in a range from 18 to 25%, and a weight average molecular weight in a range from 50,000 to 80,000. This hydro-dispersing is, for example, carried out by a method in which: the above specified acid-modified chlorinated polyolefin resin is dissolved into an ether type solvent and the solution is neutralized by adding a basic substance, and then the neutralized solution is dispersed into water by adding water, and then the ether type solvent is removed.

As to the starting material acid-modified chlorinated polyolefin resin, for example, there may be used those being obtained by graft-copolymerizing at least one compound selected from a,p-unsaturated carboxylic acids and their anhydrides onto at least one selected from polypropylene and propylene-α-olefin copolymers to obtain an acid-modified polyolefin and then chlorinating this acid-modified polyolefin.

Herein, the propylene-α-olefin copolymer is a copolymer comprising propylene as a main component and an α-olefin copolymerized therewith. Examples of usable ccα-olefins include one or more compounds such as ethylene, 1-butene, 1-heptene, 1-octene, and 4-methyl-1-pentene. Among them, ethylene and 1-butene are preferable. The ratio of the propylene component and the α-olefin component in the propylene-α-olefin copolymer is not particularly limited. However, the propylene component is preferably contained at a ratio of 50% by mole or higher and more preferably at a ratio of 90% by mole or higher.

The chlorinated polyolefin resin to be used in the present invention is an acid-modified one, and its acid modification quantity is required to be in a range from 1.6 to 2.5% by mass. If the acid modification quantity is lower than 1.6% by mass, when the molecular weight is high, it becomes difficult to obtain a dispersion in the absence of a surfactant. If it exceeds 2.5% by mass, when the molecular weight is low, the cohesive power is lowered and therefore, the initial adhesion may be decreased.

The chlorinated polyolefin resin to be used in the present invention is grafted to adjust the acid modification quantity by copolymerizing at least one compound selected from α,β-unsaturated carboxylic acids and their anhydrides in a proper amount with at least one compound selected from polypropylene and propylene-α-olefin copolymers. Examples of the α,β-unsaturated carboxylic acids and their anhydrides to be graft-copolymerized include maleic acid, itaconic acid, citraconic acid, and their acid anhydrides. Among them, the acid anhydrides are preferable, and maleic anhydride and itaconic anhydride are more preferable.

Examples of the method for graft-copolymerizing at least one compound selected from α,β-unsaturated carboxylic acids and their anhydrides onto at least one compound selected from polypropylene and propylene-α-olefin copolymers include publicly known methods such as solution methods and melting methods.

The solution method is carried out, for example, as follows: at least one compound selected from polypropylene and propylene-α-olefin copolymers is dissolved into an aromatic organic solvent such as toluene at 100 to 180° C., and then at least one compound selected from α,β-unsaturated carboxylic acids and their anhydrides is added and further a radical initiator is added in one lot or partition to carry out the reaction.

The melting method is carried out, for example, as follows: at least one compound selected from polypropylene and propylene-α-olefin copolymers is heated to a melting point or higher to thereby be melted, and then at least one compound selected from α,β-unsaturated carboxylic acids and their anhydrides is added together with a radical initiator to carry out the reaction.

Examples of the radical initiator include benzoyl peroxide, dicumyl peroxide and di-t-butyl peroxide and may be selected in accordance with the reaction temperature and the decomposition temperature.

The acid-modified polyolefin obtained by the above-mentioned method is chlorinated to obtain the acid-modified chlorinated polyolefin.

The chlorination may, for example, be carried out by dissolving the acid-modified polyolefin into a chlorine type solvent and blowing chlorine gas until the chlorine content reaches 18 to 25% by mass in the presence or absence of the radical initiator. Examples of the chlorine type solvent include tetrachloroethylene, tetrachloroethane, carbon tetrachloride, and chloroform.

The chlorine content in the acid-modified chlorinated polyolefin resin is required to be in a range from 18 to 25% by mass. It is because if the chlorine content is lower than 18% by mass, emulsification becomes difficult in the state where little or no surfactant exists, and that if it exceeds 25% by mass, the initial adhesion is inferior.

The weight average molecular weight of the acid-modified chlorinated polyolefin is required to be in a range from 50,000 to 80,000. If the weight average molecular weight is lower than 50,000, the cohesive power is low and the initial adhesion is inferior. If the weight average molecular weight exceeds 80,000, the softening temperature is slightly increased and accordingly the initial adhesion becomes inferior, too. Accordingly, the weight average molecular weight can be measured by GPC (gel permeation chromatography).

To produce the water-base resin-dispersed composition of the present invention, it is adequate to carry out a method in which: the acid-modified chlorinated polyolefin resin is dissolved into an ether type solvent, and then the resulting solution is neutralized by adding a basic substance, and then the neutralized solution is dispersed into water by adding water, and then the ether type solvent is removed.

This method will hereinafter be described step by step.

At first, the acid-modified chlorinated polyolefin is dissolved into the ether type solvent. Examples of the ether type solvent include tetrahydrofuran, propylene glycol monomethyl ether, propylene glycol monoethyl ether, and propylene glycol monopropyl ether. They may be used alone or in combination of two or more thereof. Preferable types of ether solvents are tetrahydrofuran and propylene glycol monopropyl ether.

Next, the above-obtained acid-modified chlorinated polyolefin solution is neutralized by adding a basic substance. Examples of the basic substance include: morpholine; ammonia; and amines such as methylamine, ethylamine, dimethylamine, triethylamine, ethanolamine, and dimethylethanolamine. They may be used alone or two or more of them may be used in combination. Dimethylethanolamine is a preferable basic substance.

Next, water is added to the neutralized acid-modified chlorinated polyolefin solution to form a W/O type dispersion, and then while water is subsequently added, the phase is reversed to an O/W type. The temperature of the water to be added is not particularly limited. However, it is preferably about 50 to 70° C. Furthermore, the amount of water to be added is also not limited. However, it is preferably 2 to 6 times by mass and more preferably 3 to 5 times by mass as much as that of the acid-modified chlorinated polyolefin.

In the next stage, the ether type solvent is removed from the dispersion after the phase reverse, thus obtaining the water-base resin-dispersed composition of the present invention. To remove the ether type solvent, distillation under reduced pressure will do. The vacuum degree at the time for the distillation is not particularly limited. However, it is preferably about 90 to 95 kPa. At that time, a portion of water is also removed. Incidentally, if necessary, replenishing water may be added.

<With Respect to Preparation of Water-Base Metallic Coating>

In the water-base metallic coating of the present invention, the mutual ratio (solid matter ratio A/B) of the water-based hydro-dispersion resin A and the water-based hydro-dispersion resin B is preferably in a range from 6/4 to 8/2.

Incidentally, the ratio (content) of the total solid matter of the water-based hydro-dispersion resin A and the water-based hydro-dispersion resin B as a vehicle to the total solid matter of the coating is preferably in a range from 70 to 98% by mass. If the content of the vehicle resins is lower than 70% by mass, the alkali resistance may possibly become insufficient. If the content of the vehicle resins exceeds 98% by mass, the hiding property for substrate surface may be possibly lowered.

The water-base metallic coating of the present invention contains a metallic pigment, whereby the coating is made to exhibit a metallic color. Examples of the metallic pigment include: metal-made brilliant materials (which may be either colorless or colored) such as metals or alloys (e.g. aluminum (coating aluminum), copper, zinc, nickel, tin, and aluminum oxide). One or more kinds of metallic pigments may be used. Incidentally, in order to prevent the metal (e.g. aluminum) composing the metallic pigment from sedimentation and agglomeration due to oxidation corrosion or from losing the metallic luster when forming a coating film, it is permitted to take measures of beforehand carrying out chromate treatment or oxidation prevention treatment or separately adding an antioxidant to the coating. Hereupon, examples of usable antioxidant include: organic phosphorus compounds such as lauryl phosphate and acryl phosphate polymers. The use amount may be set properly within a range so that the effects of the present invention are not adversely affected.

The content of the metallic pigment in the water-base metallic coating of the present invention is preferably in a range from 1 to 15% by mass based on the total solid matter (solid matter including the resin solid matter, the pigment, and other solid matter) in the coating. If the content of the metallic pigment is lower than 1% by mass, the metallic appearance tends to be insufficient. On the other hand, if the content exceeds 15% by mass, the cohesive power of the coating film may be possibly decreased. Therefore, both cases are unfavorable.

If necessary, the water-base metallic coating of the present invention may further contain a pigment other than the aforementioned metallic pigment within a range so that the effects of the present invention are not adversely affected. Examples of the pigment other than the aforementioned metallic pigment include: inorganic pigments such as a mica pigment, titanium oxide, carbon black, iron oxide type pigment, and chromium oxide; organic pigments such as an azo type pigment, an anthracene type pigment, a perylene type pigment, a quinacridone type pigment, an isoindolinone type pigment, an indigo type pigment, and a phthalocyanine type pigment; extender pigments such as talc, precipitated barium sulfate, and silicates; and conductive pigments such as conductive carbon. One or more of the pigments other than the metallic pigment may be used.

The water-base metallic coating of the present invention contains water as the main solvent, but may further contain an organic solvent as another solvent if the ratio of the organic solvent is less than 50% by mass increased to the total with water and is within a range so that the effects of the present invention are not adversely affected. Examples of the organic solvent include the aforementioned solvents usable in the polymerization for obtaining the water-base acrylic resin, and also the below-mentioned solvents. These organic solvents may be used alone or two or more of them may be used. In the case where the organic solvent is made to be contained, the workability is improved and the dispersibility of such as pigment is heightened. However, in general, it is preferable that no organic solvent is contained, because the storage stability of the emulsion is higher and it meets recent restrictions against the use of organic solvents.

Examples of the above-mentioned solvent include: aromatic hydrocarbons such as toluene and xylene; aliphatic hydrocarbons such as hexane, heptane, and octane; alicyclic hydrocarbons such as cyclohexane, methylcyclohexane, and cyclopentane; esters such as ethyl acetate, n-butyl acetate, isobutyl acetate, and amyl acetate; ethers such as n-butyl ether and isobutyl ether; ketones such as acetone, methyl ethyl ketone, methyl isobutyl ketone, and cyclohexanone; alcohols such as methanol, ethanol, isopropanol, n-butanol, 2-butanol, n-propylene glycol, and isopropylene glycol; cellosolves such as ethylene glycol monomethyl ether, ethylene glycol monobutyl ether, and ethylene glycol monoethyl ether acetate; carbitols such as diethylene glycol monoethyl ether; propylene glycol monoalkyl ethers such as propylene glycol monomethyl ether, propylene glycol monoethyl ether, and propylene glycol monobutyl ether; and other solvents such as dioxane, N-methylpyrrolidone, dimethylformamide, and diacetone alcohol.

Based on the necessity, the water-base metallic coating of the present invention may contain another water-base resin and additives such as a thickener, a defoaming agent, a pigment dispersant, a surface conditioner, a leveling agent, a WV absorbent, an antioxidant, an antiseptic, an anti-mold agent, a plasticizer, a conductive material, an electromagnetic wave absorbent, and a malodorous substance absorbent within a range so that the effects of the present invention are not adversely affected. The above-mentioned other water-base resin is most preferably a water-soluble acrylic resin. However, other than the water-soluble acrylic resin, such as a polyester resin emulsion, a polyurethane resin emulsion, an epoxy resin emulsion, or an amino resin emulsion, also may be added.

The water-base metallic coating of the present invention can be obtained by evenly mixing the above-mentioned components by conventional methods. For example, the coating may be obtained by, sequentially or all at once, adding the above-mentioned components to a container equipped with a stirrer under stirring and evenly mixing them. Further, the pigment may be previously dispersed into a part or all of the vehicles to a needed level to prepare a pigment paste and then added.

The water-base metallic coating of the present invention preferably has pH in a range from 7 to 10 and, if necessary, pH adjustment may be carried out using the above-mentioned neutralization agent used for hydro-dispersing the water-base acrylic resin, within a range so that the effects of the present invention are not adversely affected.

The water-base metallic coating of the present invention can be coated directly to a substrate to be coated and also may be coated onto a primer coating film after the primer coating film to be an undercoat has been formed on the substrate to be coated.

The coating method for coating the water-base metallic coating of the present invention is not particularly limited, and publicly known methods such as air spray coating, bell coating, rotary disc coating, immersion coating, and brush coating may be employed. Further, electrostatic current may be applied at the time of coating to enhance the coating deposition efficiency.

The coating amount of the water-base metallic coating of the present invention at the time of coating may be properly set in accordance with the uses, so there is no especial limitation. However, for example, in the case of the use for interior materials, it is proper to give a film thickness in dry state preferably in a range from 10 to 50 μm and more preferably in a range from 15 to 40 μm. If the film thickness in dry state is too thin, it may possibly be impossible to completely hide the color of the substrate to be coated and also it may possibly become difficult to form a smooth coating film. On the other hand, if the film thickness in dry state is too thick, there is a tendency that a popping phenomenon occurs at the time of drying or that the orientation of the metallic pigment becomes disordered to lower the brilliancy.

The drying temperature of the coating film, after having coated the water-base metallic coating of the present invention, may be properly set in consideration of the heat resistance of the substrate to be coated and is thus not particularly limited. However, for example, it is properly set in a range from 60 to 140° C. In addition, on that occasion, the drying time may be in a range, for example, from about 5 to about 60 minutes although it depends on the drying temperature.

A coated article which is a substrate of the water-base metallic coating for automotive interior materials of the present invention may include substrates of automotive interior materials made of various materials such as plastics, and besides, automotive bodies themselves in which these substrates are assembled. The above-mentioned plastics may include, for example, polyolefins such as polypropylene (PP) and polyethylene (PE); acrylonitrile-styrene polymer (AS), acrylonitrile-butadiene-styrene (ABS), polyphenylene oxide (PPO), polyvinyl chloride (PVC), polyurethane (PU) and polycarbonate (PC).

### DETAILED DESCRIPTION OF THE PREFERRED EMBODIMENTS

Hereinafter, the present invention is more specifically illustrated by the following Examples of some preferred embodiments in comparison with Comparative Examples not according to the present invention. However, the present invention is not limited to these. Hereinafter, unless otherwise noted, the unit “mass part(s)” is referred to simply as “part(s)”. [Production of Water-Based Hydro-Dispersion resins A]

<Production of Resin A-1>

At first 82.7 parts of isopropyl alcohol was put into a reaction container and heated to 73° C. while being stirred and mixed in a nitrogen current. Then, into this reaction container, 39.9 parts of methyl methacrylate (MMA), 25.3 parts of isobutyl methacrylate (IBMA), 31.7 parts of isobomyl methacrylate (IBX), and 3.1 parts of methacrylic acid (MAA) were dropwise added for 3 hours and simultaneously an initiator solution comprising 10.0 parts of methyl isobutyl ketone and 0.7 parts of 2,2′-azobis(2,4-diemthylvaleronitrile) was also dropwise added. After the completion of the dropwise addition, aging was carried out at the same temperature for 0.5 hours. Thereafter, an initiator solution comprising 5.0 parts of methyl isobutyl ketone and 0.2 parts of 2,2′-azobis(2,4-diemthylvaleronitrile) was further dropwise added for 0.5 hours into the reaction container. After the completion of the dropwise addition, aging was carried out at the same temperature for 2 hours to obtain an acrylic resin with a non-volatile matter of 50% by mass, a solid matter acid value of 20, and a weight average molecular weight (Mw)=45,000. Then, 3.2 parts of dimethylethanolamine was added to the acrylic resin and evenly dispersed. After the resulting dispersion had been cooled to 60° C., 325.0 parts of deionized water was dropwise added for 1 hour. Thereafter, 190.0 parts of the solvent was distilled off at 50° C. under reduced pressure (70 Torr) by a desolvation apparatus to obtain a hydrophobic acrylic resin water dispersion (water-based hydro-dispersion resin A-1). The non-volatile matter in this water dispersion was 30% by mass.

<Production of Resins A-2 to A-14>

Water-based hydro-dispersion resins A-2 to A-14 were produced from compositions such that only the amounts of the charged monomers was as shown in Table 1, by the same method as the production of the water-based hydro-dispersion resin A-1. In the monomer expressions in Table 1, NBA stands for n-butyl acrylate; TBMA stands for tert-butyl methacrylate; and St stands for styrene. The non-volatile matter in all of those water dispersions was also 30% by mass.

As is shown in Table 1, the water-based hydro-dispersion resin A-14 contains styrene as a monomer component. Incidentally, in the production of the water-based hydro-dispersion resin A-10, since the acid value of the acrylic resin was as low as 8 mgKOH/g, hydro-dispersing was impossible.

[Production of Water-Based Hydro-Dispersion Resins B]

<Production of Resin B-1>

(Modification with Maleic Anhydride)

A 1-L capacity reaction container equipped with a stirring blade and a thermometer was installed into a temperature-controllable oil bath and charged with 300 parts of isotactic polypropylene (ISOTPP) with a weight average molecular weight (Mw) of 180,000. The inner temperature of the reaction container was raised to 180° C. by heating with the oil bath. Next, 3 parts of maleic anhydride (MAn) and 3 parts of di-tert-butyl peroxide (DTBPO) were gradually added for 2 hours and then the reaction was continued for 2 hours to obtain an acid-anhydride-modified polypropylene resin with a weight average molecular weight of 70,000 and a maleic acid addition amount of 2%.

(Chlorination)

A 1-L capacity reaction container equipped with a stirring blade, a gas blowing l0 inlet, a gas discharge port, and a thermometer was installed into a temperature-controllable oil bath and charged with 300 parts of the above-mentioned acid-anhydride-modified polypropylene resin. The inner temperature of the reaction container was raised to 180° C. by heating with the oil bath to put the resin into a complete solution state. Next, while the contents were being strongly stirred, chlorine gas was blown in from the container bottom part to carry out a chlorination reaction. At proper times, the inside resin was sampled and subjected to chlorine content measurement. When the chlorine content reached 20%, the reaction was stopped and the reaction product was cooled to obtain an acid-anhydride-modified chlorinated polypropylene resin (acid-modified CLPP).

(Water-Basing)

A 1-L capacity reaction container equipped with a stirring blade, a thermometer, and a refluxing condenser was installed into a temperature-controllable hot water bath and charged with 50 parts of the above acid-anhydride-modified chlorinated polypropylene resin and then with 93 parts of tetrahydrofuran and 24 parts of propylene glycol monopropyl ether. The inner temperature of the reaction container was gradually raised to 65° C. After the temperature was kept for 1 hour, 0.9 parts of diethanolamine was added. While the liquid temperature in the reaction container was kept at 65° C., 167 parts of water of 65° C. was gradually dropwise added for 1 hour to reverse the phase from a W/O type to O/W type dispersion. The obtained water dispersion was put under reduced pressure of 91 kPa to remove tetrahydrofuran, propylene glycol monopropyl ether, and a portion of water and thereby obtain a water-based hydro-dispersion resin B-1. The solid matter of the resin B-1 was 30% by mass.

<Production of Resins B-2 to B-10>

Water-based hydro-dispersion resins B-2 to B-10 having the formulated compositions and properties as shown in Table 2 were produced by the same method as the production of the above-mentioned water-based hydro-dispersion resin B-1. The non-volatile matter in all of those water dispersions was also 30% by mass.

As shown in Table 2, only at the time of the production of the water-based hydro-dispersion resin B-6, a surfactant was used. Incidentally, in the production of the water-based hydro-dispersion resin B-7, the acid modification quantity of the acid-anhydride-modified chlorinated polypropylene resin was as low as 1.4% by mass. Also, in the production of the water-based hydro-dispersion resin B-9, the chlorine content of the acid-anhydride-modified chlorinated polypropylene resin was as low as 15%. Therefore, in both cases, the hydro-dispersing was impossible.

Tables 1 and 2 also show properties (theoretical Tg, AV (acid value), SP (solubility parameter) of the acrylic resins used for the production of the water-based hydro-dispersion resins A-1 to A-14 as well as properties (acid modification quantity, chlorine content, and Mw (weight average molecular weight)) of the acid-anhydride-modified chlorinated polypropylene resins used for the production of the water-based hydro-dispersion resins B-1 to B-10.

TABLE 1
Production of water-based hydro-dispersion resins A

| | Resin | Resin | | Resin | Resin | Resin | |
|---|---|---|---|---|---|---|---|
| For Example | A-1 | A-2 | Resin A-3 | A-4 | A-5 | A-6 | Resin A-7 |
| IBX | 31.69 | 37.90 | 41.07 | 29.76 | 32.97 | 35.19 | 28.19 |
| IBMA | 25.27 | | 6.43 | 22.55 | 27.09 | 28.54 | 22.01 |
| MAA | 3.07 | 3.07 | 3.07 | 2.15 | 3.68 | 3.07 | 3.07 |
| MMA | 39.97 | 43.94 | 49.43 | 45.54 | 36.26 | 33.20 | 46.74 |
| NBA | | 15.09 | | | | | |
| St | | | | | | | |
| Theoretical Tg | 110° C. | 90° C. | 130° C. | 110° C. | 110° C. | 110° C. | 110° C. |
| AV | 20 | 20 | 20 | 14 | 24 | 20 | 20 |
| SP | 9.75 | 9.75 | 9.75 | 9.75 | 9.75 | 9.60 | 9.90 |
| St containing | None | None | None | None | None | None | None |
| Hydro-dispersing | Possible | Possible | Possible | Possible | Possible | Possible | Possible |
| For Comparative | Resin | Resin | Resin | Resin | Resin | Resin | Resin |
| Example | A-8 | A-9 | A-10 | A-11 | A-12 | A-13 | A-14 |
| IBX | 35.52 | 49.99 | 27.84 | 34.90 | 42.20 | 25.95 | 25.46 |
| IBMA | | | 19.83 | 29.81 | 35.07 | 12.76 | 18.34 |
| MAA | 3.07 | 3.84 | 1.23 | 4.60 | 3.07 | 3.07 | 3.07 |
| MMA | 40.69 | 33.61 | 51.10 | 30.69 | 19.66 | 58.22 | 38.14 |
| TBMA | | 12.56 | | | | | |
| NBA | 20.73 | | | | | | |
| St | | | | | | | |
| Theoretical Tg | 75° C. | 143° C. | 110° C. | 110° C. | 110° C. | 115° C. | 110° C. |
| AV | 20 | 25 | 8 | 30 | 20 | 20 | 20 |
| SP | 9.75 | 9.50 | 9.75 | 9.75 | 9.30 | 10.10 | 9.75 |
| St containing | None | None | None | None | None | None | Containing |
| Hydro-dispersing | Possible | Possible | Impossible | Possible | Possible | Possible | Possible |

TABLE 2
Production of water-based hydro-dispersion resins B

| For Example | Resin B-1 | Resin B-2 | Resin B-3 | Resin B-4 | Resin B-5 |
|---|---|---|---|---|---|
| ISOTPP | 300.0 | 300.0 | 300.0 | 300.0 | 300.0 |
| MAn | 3.0 | 2.5 | 4.0 | 3.0 | 3.0 |
| DTBPO | 3.0 | 3.0 | 3.0 | 3.0 | 3.0 |
| MAn addition amount | 2.0 | 1.7 | 2.3 | 2.0 | 2.0 |
| Chlorine addition amount | 20.0 | 20.0 | 20.0 | 18.0 | 24.0 |
| Use of surfactant | None | None | None | None | None |
| Acid | 2.0 Wt % | 1.7 | 2.3 | 2.0 | 2.0 |
| modification | | | | | |
| quantity | | | | | |
| Chlorine content | 20 | 20 | 20 | 18 | 24 |
| Mw | 70,000 | 70,000 | 70,000 | 70,000 | 70,000 |
| Use of surfactant | None | None | None | None | None |
| Hydro-dispersing | Possible | Possible | Possible | Possible | Possible |
| For Comparative | | | | | Resin |
| Example | Resin B-6 | Resin B-7 | Resin B-8 | Resin B-9 | B-10 |
| ISOTPP | 300.0 | 300.0 | 300.0 | 300.0 | 300.0 |
| MAn | 3.0 | 2.0 | 4.0 | 3.0 | 3.0 |
| DTBPO | 3.0 | 2.5 | 5.0 | 3.0 | 3.0 |
| MAn addition amount | 2.0 | 1.4 | 3.0 | 2.0 | 2.0 |
| Chlorine addition amount | 20.0 | 20.0 | 20.0 | 15.0 | 28.0 |
| Surfactant | 3.0 | None | None | None | None |
| Acid | 2.0 | 1.4 | 3.0 | 2.0 | 2.0 |
| modification | | | | | |
| quantity | | | | | |
| Chlorine content | 20 | 20 | 20 | 15 | 28 |
| Mw | 70,000 | 90,000 | 50,000 | 70,000 | 70,000 |
| Use of surfactant | Using | None | None | None | None |
| Hydro-dispersing | Possible | Impossible | Possible | Impossible | Possible |

[Production of Coatings and Production of Coated Articles]

### EXAMPLE 1

A container equipped with a stirrer was charged with 70 parts of the water-based hydro-dispersion resin A-1, 1.0 part of a surface conditioner (Dynol 604, manufactured by Air Products Ltd.), 4.0 parts of aluminum (“Hydrolan 3560”, manufactured by ECKART), 6 parts of propylene glycol n-butyl ether, and 20 parts of deionized water in order under stirring and then further charged with 30 parts of the water-based hydro-dispersion resin B-1 and 1.0 part of a thickener (“Adekanol UH752”, manufactured by ADEKA). After the completion of the charging of all components, the mixture was stirred further for 1 hour to obtain a water-base metallic coating.

After the surface of a commercialized polypropylene substrate (100 mm×350 mm×3 mm) had been wiped with isopropyl alcohol, the above-mentioned water-base metallic coating was applied by air spray coating to the surface of the substrate so as to give a dry film thickness of 20 μm and then heat-dried at 80° C. for 25 minutes to obtain a test piece.

### EXAMPLES 2 TO 13 AND COMPARATIVE EXAMPLES 1 TO 8

By the same method as Example 1, coatings of Examples 2 to 13 and Comparative Examples 1 to 8 were produced in accordance with the “Material formulations for coatings” shown in Tables 3 and 4 and the “Properties and resin formulations of coatings” shown in Tables 5 and 6, and test pieces were also produced using these coatings.

TABLE 3
Material formulations for coatings of Examples

| | Example 1 | | Example 2 | | Example 3 | | Example 4 | | Example 5 | | Example 6 | |
|---|---|---|---|---|---|---|---|---|---|---|---|---|
| | Solid | | Solid | | Solid | | Solid | | Solid | | Solid | |
| | matter | Solution | matter | Solution | matter | Solution | matter | Solution | matter | Solution | matter | Solution |
| Resin A | Resin A-1 | | Resin A-2 | | Resin A-3 | | Resin A-4 | | Resin A-5 | | Resin A-6 | |
| | 21.0 | 70.0 | 21.0 | 70.0 | 21.0 | 70.0 | 21.0 | 70.0 | 21.0 | 70.0 | 21.0 | 70.0 |
| Resin B | Resin B-1 | | Resin B-1 | | Resin B-1 | | Resin B-1 | | Resin B-1 | | Resin B-1 | |
| | 9.0 | 30.0 | 9.0 | 30.0 | 9.0 | 30.0 | 9.0 | 30.0 | 9.0 | 30.0 | 9.0 | 30.0 |
| Metallic | 2.4 | 4.0 | 2.4 | 4.0 | 2.4 | 4.0 | 2.4 | 4.0 | 2.4 | 4.0 | 2.4 | 4.0 |
| pigment *1 | | | | | | | | | | | | |
| Thickener *2 | 0.2 | 1.0 | 0.2 | 1.0 | 0.2 | 1.0 | 0.2 | 1.0 | 0.2 | 1.0 | 0.2 | 1.0 |
| Surface | 1.0 | 1.0 | 1.0 | 1.0 | 1.0 | 1.0 | 1.0 | 1.0 | 1.0 | 1.0 | 1.0 | 1.0 |
| conditioner *3 | | | | | | | | | | | | |
| Solvent *4 | 0.0 | 6.0 | 0.0 | 6.0 | 0.0 | 6.0 | 0.0 | 6.0 | 0.0 | 6.0 | 0.0 | 6.0 |
| Deionized | 0.0 | 20.0 | 0.0 | 20.0 | 0.0 | 20.0 | 0.0 | 20.0 | 0.0 | 20.0 | 0.0 | 20.0 |
| water | | | | | | | | | | | | |
| Total amount | 33.6 | 132.0 | 33.6 | 132.0 | 33.6 | 132.0 | 33.6 | 132.0 | 33.6 | 132.0 | 33.6 | 132.0 |

| | Example 7 | | Example 8 | | Example 9 | | Example 10 | | Example 11 | | Example 12 | | Example 13 | |
|---|---|---|---|---|---|---|---|---|---|---|---|---|---|---|
| | Solid | | Solid | | Solid | | Solid | | Solid | | Solid | | Solid | |
| | matter | Solution | matter | Solution | matter | Solution | matter | Solution | matter | Solution | matter | Solution | matter | Solution |
| Resin A | Resin A-7 | | Resin A-1 | | Resin A-1 | | Resin A-1 | | Resin A-1 | | Resin A-1 | | Resin A-1 | |
| | 21.0 | 70.0 | 21.0 | 70.0 | 21.0 | 70.0 | 21 | 70 | 21 | 70 | 22.5 | 75 | 19.5 | 65 |
| Resin B | Resin B-1 | | Resin B-2 | | Resin B-3 | | Resin B-4 | | Resin B-5 | | Resin B-1 | | Resin B-1 | |
| | 9.0 | 30.0 | 9.0 | 30.0 | 9.0 | 30.0 | 9 | 30 | 9 | 30 | 7.5 | 25 | 10.5 | 35 |
| Metallic | 2.4 | 4.0 | 2.4 | 4.0 | 2.4 | 4.0 | 2.4 | 4.0 | 2.4 | 4.0 | 2.4 | 4.0 | 2.4 | 4.0 |
| pigment *1 | | | | | | | | | | | | | | |
| Thickener *2 | 0.2 | 1.0 | 0.2 | 1.0 | 0.2 | 1.0 | 0.2 | 1.0 | 0.2 | 1.0 | 0.2 | 1.0 | 0.2 | 1.0 |
| Surface | 1.0 | 1.0 | 1.0 | 1.0 | 1.0 | 1.0 | 1.0 | 1.0 | 1.0 | 1.0 | 1.0 | 1.0 | 1.0 | 1.0 |
| conditioner *3 | | | | | | | | | | | | | | |
| Solvent *4 | 0.0 | 6.0 | 0.0 | 6.0 | 0.0 | 6.0 | 0.0 | 6.0 | 0.0 | 6.0 | 0.0 | 6.0 | 0.0 | 6.0 |
| Deionized | 0.0 | 20.0 | 0.0 | 20.0 | 0.0 | 20.0 | 0.0 | 20.0 | 0.0 | 20.0 | 0.0 | 20.0 | 0.0 | 20.0 |
| water | | | | | | | | | | | | | | |
| Total amount | 33.6 | 132.0 | 33.6 | 132.0 | 33.6 | 132.0 | 33.6 | 132.0 | 33.6 | 132.0 | 33.6 | 132.0 | 33.6 | 132.0 |

*1: Hydrolan 3560 (manufactured by ECKART: solid matter 60%)
*2: Adekanol UH-752 (manufactured by ADEKA: solid matter 20%)
*3: Dynol 604 (manufactured by Air Products Ltd.: solid matter 100%)
*4: Propylene glycol n-butyl ether

TABLE 4
Material formulations for coatings of Comparative Examples

| | Comparative | | Comparative | | Comparative | | Comparative | |
|---|---|---|---|---|---|---|---|---|
| | Example 1 | | Example 2 | | Example 3 | | Example 4 | |
| | Solid | | Solid | | Solid | | Solid | |
| | matter | Solution | matter | Solution | matter | Solution | matter | Solution |
| Resin A | Resin A-8 | | Resin A-9 | | Resin A-11 | | Resin A-12 | |
| | 21 | 70 | 21 | 70 | 21 | 70 | 21 | 70 |
| Resin B | Resin B-1 | | Resin B-1 | | Resin B-1 | | Resin B-1 | |
| | 9 | 30 | 9 | 30 | 9 | 30 | 9 | 30 |
| Metallic | 2.4 | 4.0 | 2.4 | 4.0 | 2.4 | 4.0 | 2.4 | 4.0 |
| pigment *1 | | | | | | | | |
| Thickener *2 | 0.2 | 1.0 | 0.2 | 1.0 | 0.2 | 1.0 | 0.2 | 1.0 |
| Surface | 1.0 | 1.0 | 1.0 | 1.0 | 1.0 | 1.0 | 1.0 | 1.0 |
| conditioner *3 | | | | | | | | |
| Solvent *4 | 0.0 | 6.0 | 0.0 | 6.0 | 0.0 | 6.0 | 0.0 | 6.0 |
| Deionized | 0.0 | 20.0 | 0.0 | 20.0 | 0.0 | 20.0 | 0.0 | 20.0 |
| water | | | | | | | | |
| Total amount | 33.6 | 132.0 | 33.6 | 132.0 | 33.6 | 132.0 | 33.6 | 132.0 |
| | Comparative | | Comparative | | Comparative | | Comparative | |
| | Example 5 | | Example 6 | | Example 7 | | Example 8 | |
| | Solid | | Solid | | Solid | | Solid | |
| | matter | Solution | matter | Solution | matter | Solution | matter | Solution |
| Resin A | Resin A-13 | | Resin A-14 | | Resin A-1 | | Resin A-1 | |
| | 21 | 70 | 21 | 70 | 21 | 70 | 21 | 70 |
| Resin B | Resin B-1 | | Resin B-6 | | Resin B-8 | | Resin B-10 | |
| | 9 | 30 | 9 | 30 | 9 | 30 | 9 | 30 |
| Metallic | 2.4 | 4.0 | 2.4 | 4.0 | 2.4 | 4.0 | 2.4 | 4.0 |
| pigment *1 | | | | | | | | |
| Thickener *2 | 0.2 | 1.0 | 0.2 | 1.0 | 0.2 | 1.0 | 0.2 | 1.0 |
| Surface | 1.0 | 1.0 | 1.0 | 1.0 | 1.0 | 1.0 | 1.0 | 1.0 |
| conditioner *3 | | | | | | | | |
| Solvent *4 | 0.0 | 6.0 | 0.0 | 6.0 | 0.0 | 6.0 | 0.0 | 6.0 |
| Deionized | 0.0 | 20.0 | 0.0 | 20.0 | 0.0 | 20.0 | 0.0 | 20.0 |
| water | | | | | | | | |
| Total amount | 33.6 | 132.0 | 33.6 | 132.0 | 33.6 | 132.0 | 33.6 | 132.0 |

*1: Hydrolan 3560 (manufactured by ECKART: solid matter 60%)
*2: Adekanol UH-752 (manufactured by ADEKA: solid matter 20%)
*3: Dynol 604 (manufactured by Air Products Ltd.: solid matter 100%)
*4: Propylene glycol n-butyl ether

TABLE 5
Properties and resin formulations of coatings of Examples

| | | Example 1 | Example 2 | Example 3 | Example 4 | Example 5 | Example 6 | Example 7 |
|---|---|---|---|---|---|---|---|---|
| Resin A | Kind of resin | Resin | Resin | Resin | Resin | Resin | Resin | Resin |
| | | A-1 | A-2 | A-3 | A-4 | A-5 | A-6 | A-7 |
| | Theoretical glass | 110 | 90 | 130 | 110 | 110 | 110 | 110 |
| | transition | | | | | | | |
| | temperature ° C. (80 | | | | | | | |
| | to 140) | | | | | | | |
| | Acid value | 20 | 20 | 20 | 14 | 24 | 20 | 20 |
| | mgKOH/g (10 to | | | | | | | |
| | 25) | | | | | | | |
| | Solubility parameter | 9.75 | 9.75 | 9.75 | 9.75 | 9.75 | 9.60 | 9.90 |
| | (9.5 to 10.0) | | | | | | | |
| | Styrene containing | None | None | None | None | None | None | None |
| Resin B | Kind of resin | Resin | Resin | Resin | Resin | Resin | Resin | Resin |
| | | B-1 | B-1 | B-1 | B-1 | B-1 | B-1 | B-1 |
| | Use of surfactant | None | None | None | None | None | None | None |
| | Acid modification | 2.0 | 2.0 | 2.0 | 2.0 | 2.0 | 2.0 | 2.0 |
| | quantity % by mass | | | | | | | |
| | (1.6 to 2.5) | | | | | | | |
| | Chlorine content % | 20 | 20 | 20 | 20 | 20 | 20 | 20 |
| | (18 to 25) | | | | | | | |
| | Weight average | 70,000 | 70,000 | 70,000 | 70,000 | 70,000 | 70,000 | 70,000 |
| | molecular weight | | | | | | | |
| | (50,000 to 80,000) | | | | | | | |
| Resin A/Resin B | | 7/3 | 7/3 | 7/3 | 7/3 | 7/3 | 7/3 | 7/3 |
| (solid matter ratio) | | | | | | | | |
| Properties | Water-resistant | ◯ | ◯ | ◯ | ◯ | ◯ | ◯ | ◯ |
| | secondary adhesion | | | | | | | |
| | Alkali resistance | ◯ | ◯ | ◯ | ◯ | ◯ | ◯ | ◯ |
| | Engine oil | ◯ | ◯ | ◯ | ◯ | ◯ | ◯ | ◯ |
| | resistance | | | | | | | |

| | | | | Example | Example | Example | Example |
|---|---|---|---|---|---|---|---|
| | | Example 8 | Example 9 | 10 | 11 | 12 | 13 |
| Resin A | Kind of resin | Resin | Resin | Resin | Resin | Resin | Resin |
| | | A-1 | A-1 | A-1 | A-1 | A-1 | A-1 |
| | Theoretical glass | 110 | 110 | 110 | 110 | 110 | 110 |
| | transition | | | | | | |
| | temperature ° C. (80 | | | | | | |
| | to 140) | | | | | | |
| | Acid value | 20 | 20 | 20 | 20 | 20 | 20 |
| | mgKOH/g (10 to | | | | | | |
| | 25) | | | | | | |
| | Solubility parameter | 9.75 | 9.75 | 9.75 | 9.75 | 9.75 | 9.75 |
| | (9.5 to 10.0) | | | | | | |
| | Styrene containing | None | None | None | None | None | None |
| Resin B | Kind of resin | Resin | Resin | Resin | Resin | Resin | Resin |
| | | B-2 | B-3 | B-4 | B-5 | B-1 | B-1 |
| | Use of surfactant | None | None | None | None | None | None |
| | Acid modification | 1.7 | 2.3 | 2.0 | 2.0 | 2.0 | 2.0 |
| | quantity % by mass | | | | | | |
| | (1.6 to 2.5) | | | | | | |
| | Chlorine content % | 20 | 20 | 18 | 24 | 20 | 20 |
| | (18 to 25) | | | | | | |
| | Weight average | 70,000 | 70,000 | 70,000 | 70,000 | 70,000 | 70,000 |
| | molecular weight | | | | | | |
| | (50,000 to 80,000) | | | | | | |
| Resin A/Resin B | | 7/3 | 7/3 | 7/3 | 7/3 | 7.5/2.5 | 6.5/3.5 |
| (solid matter ratio) | | | | | | | |
| Properties | Water-resistant | ◯ | ◯ | ◯ | ◯ | ◯ | ◯ |
| | secondary adhesion | | | | | | |
| | Alkali resistance | ◯ | ◯ | ◯ | ◯ | ◯ | ◯ |
| | Engine oil | ◯ | ◯ | ◯ | ◯ | ◯ | ◯ |
| | resistance | | | | | | |

TABLE 6
Properties and resin formulations of coatings of Comparative Examples

| | | Comparative | Comparative | Comparative | Comparative | Comparative | Comparative | Comparative | Comparative |
|---|---|---|---|---|---|---|---|---|---|
| | | Example 1 | Example 2 | Example 3 | Example 4 | Example 5 | Example 6 | Example 7 | Example 8 |
| Resin A | Kind of resin | Resin A-8 | Resin A-9 | Resin A-11 | Resin A-12 | Resin A-13 | Resin A-14 | Resin A-1 | Resin A-1 |
| | Theoretical glass | 75 | 143 | 110 | 110 | 115 | 110 | 110 | 110 |
| | transition temperature | | | | | | | | |
| | ° C. (80 to 140) | | | | | | | | |
| | Acid value mgKOH/g | 20 | 25 | 30 | 20 | 20 | 20 | 20 | 20 |
| | (10 to 25) | | | | | | | | |
| | Solubility parameter | 9.75 | 9.50 | 9.75 | 9.30 | 10.1 | 9.75 | 9.75 | 9.75 |
| | (9.5 to 10.0) | | | | | | | | |
| | Styrene containing | None | None | None | None | None | Containing | None | None |
| Resin B | Kind of resin | Resin B-1 | Resin B-1 | Resin B-1 | Resin B-1 | Resin B-1 | Resin B-6 | Resin B-8 | Resin B-10 |
| | Use of surfactant | None | None | None | None | None | Using | None | None |
| | Acid modification | 2.0 | 2.0 | 2.0 | 2.0 | 2.0 | 2.0 | 3.0 | 2.0 |
| | quantity % by mass | | | | | | | | |
| | (1.6 to 2.5) | | | | | | | | |
| | Chlorine content % | 20 | 20 | 20 | 20 | 20 | 20 | 20 | 28 |
| | (18 to 25) | | | | | | | | |
| | Weight average | 70,000 | 70,000 | 70,000 | 70,000 | 70,000 | 70,000 | 50,000 | 70,000 |
| | molecular weight | | | | | | | | |
| | (50,000 to 80,000) | | | | | | | | |
| Resin A/Resin B | | 7/3 | 7/3 | 7/3 | 7/3 | 7/3 | 7/3 | 7/3 | 7/3 |
| (solid matter ratio) | | | | | | | | | |
| Properties | Water-resistant | ◯ | X | ◯ | ◯ | ◯ | ◯ | X | X |
| | secondary adhesion | | | | | | | | |
| | Alkali resistance | X | ◯ | X | ◯ | X | X | X | ◯ |
| | Engine oil resistance | X | ◯ | ◯ | X | ◯ | X | ◯ | ◯ |

The test pieces of Examples 1 to 13 and Comparative Examples 1 to 8 were subjected to the following three evaluations, and the results are shown in Tables 5 and 6 above.

<Water-Resistant Secondary Adhesion>

Each test piece was immersed into a thermostatic water bath adjusted to 40° C. and then taken out of the bath after 24 hours and compared with a blank of the same test piece to confirm the discoloration degree, peeling, and occurrence of cracks by eye observation and finger touch, and the adhesion was also confirmed by a lattice (2 mm width) cross-hatching tape test.

◯: There is no discoloration, no peeling, and no cracking, and also there is no peeling by the adhesion test.

X: There is discoloration, peeling, and cracking, or there is peeling by the adhesion test.

<Alkali Resistance>

A cylinder with an inner diameter of 40 mm and a height of 15 mm made of polyethylene was put on a coating film of each test piece. The gap between the cylinder and the coating film was sealed with an adhesive so as to prevent leakage of a liquid from the part contacting the coating film surface. Thereafter, 5 ml of an aqueous 0.1 N sodium hydroxide solution was poured into the cylinder, and then the inside was put in an airtight state by covering the upper part of the cylinder with a watch glass. They were left in this state under an atmosphere of 55° C. for 8 hours. Thereafter, the aqueous sodium hydroxide solution was discarded out of the cylinder, and the cylinder was released from the coating film, which was then washed with water and air-dried. The color difference ΔE (delta E) between the portion having been brought into contact with the aqueous sodium hydroxide solution and the non-contacted portion was measured by a colorimeter (“MINOLTA CR-200”, manufactured by MINOLTA Co., Ltd.). Judgment was done according to the following standard.
◯: ΔE<1.5, X: ΔE≧1.5
<Engine Oil Resistance>

An engine oil in an amount of 0.2 ml was dripped onto each horizontally placed test piece, which was then heated in a thermostatic bath of 80° C. for 4 hours and then taken out of the thermostatic bath and then wiped with soft cloth having been impregnated with a neutral detergent. The coating film was scratched with a craw to observe whether the coating film was peeled or not. The test piece whose coating film had not been peeled by the scratching was evaluated as success. “Ultrapure Ultra Oil (trade name)” manufactured by Honda Giken Kogyo Kabushiki Kaisha was used as the engine oil.

### INDUSTRIAL APPLICATION

Even if neither a surfactant nor styrene is used, while environmental protection is made at the time of coating, the water-base metallic coating for automotive interior materials of the present invention is excellent in the adhesion to a plastic substrate and further has high-level alkali resistance and is usable favorably for obtaining automotive interior materials of metallic colors.

What is claimed is:

1. A water-base metallic coating for automotive interior materials, comprising a metallic pigment and a vehicle, wherein the vehicle includes: a first water-based hydro-dispersion resin A obtained by hydro-dispersing, without using a surfactant, an acrylic resin which indispensably contains isobomyl methacrylate as a monomer component and no styrene and has a theoretical Tg in a range from 80 to 140° C., an acid value in a range from 10 to 25 mgKOH/g, and an SP value in a range from 9.5 to 10.0; and a second water-based hydro-dispersion resin B obtained by hydro-dispersing, without using a surfactant, an acid-modified chlorinated polyolefin resin having an acid modification quantity in a range from 1.6 to 2.5% by mass, a chlorine content in a range from 18 to 25%, and a weight average molecular weight in a range from 50,000 to 80,000.

2. The water-base metallic coating for automotive interior materials according to claim 1, wherein the ratio of the isobornyl methacrylate in polymerizable monomer components for synthesizing the acrylic resin is in a range from 20 to 50% by mass.

3. The water-base metallic coating for automotive interior materials according to claim 1, wherein the mutual ratio (solid matter ratio A/B) of the hydro-dispersion resin A and the hydro-dispersion resin B is in a range from 6/4 to 8/2.

4. The water-base metallic coating for automotive interior materials according to claim 1, wherein the ratio of the total solid matter of the hydro-dispersion resin A and the hydro-dispersion resin B to the total solid matter of the coating is in a range from 70 to 98% by mass.

5. The water-base metallic coating for automotive interior materials according to claim 1, wherein the ratio of the metallic pigment to the total solid matter of the coating is in a range from 1 to 15% by mass.

6. A coated article, coated with the water-base metallic coating as recited in claim 1.
